(19) United States
(12) Patent Application Publication
(10) Pub. No.: US 2016/0133400 A1
(43) Pub. Date: May 12, 2016

(54) TATTOO GUN SWITCH DEVICE

(71) Applicant: Chadrick McClendon, Ellenwood, GA (US)

(72) Inventor: Chadrick McClendon, Ellenwood, GA (US)

(21) Appl. No.: 14/534,731

(22) Filed: Nov. 6, 2014

(51) Int. Cl. H01H 9/06; H01H 1/12

(52) U.S. Cl. CPC H01H 9/06; H01H 1/12; H01H 2217/00; H01H 2231/024; H01H 2231/048; H01H 2300/026

(57) ABSTRACT

A tattoo gun switch assembly for replacing a foot switch for a tattoo gun includes a grip structured to have a cylindrical shape to be coupled to a tattoo gun. A switch is coupled to the grip to be accessible to a user. Thus, the switch replaces a foot switch.

### BACKGROUND OF THE DISCLOSURE

### Field of the Disclosure

The disclosure relates to switch devices and more particularly pertains to a new switch device for replacing a foot switch for a tattoo gun.

### SUMMARY OF THE DISCLOSURE

An embodiment of the disclosure meets the needs presented above by generally comprising a grip structured to have a cylindrical shape to be coupled to a tattoo gun. A switch is coupled to the grip to be accessible to a user. Thus, the switch replaces a foot switch.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a tattoo gun switch according to an embodiment of the disclosure.

FIG. 2 is a front view of an embodiment of the disclosure.

FIG. 3 is a left side view of an embodiment of the disclosure.

### DESCRIPTION OF THE PREFERRED EMBODIMENT

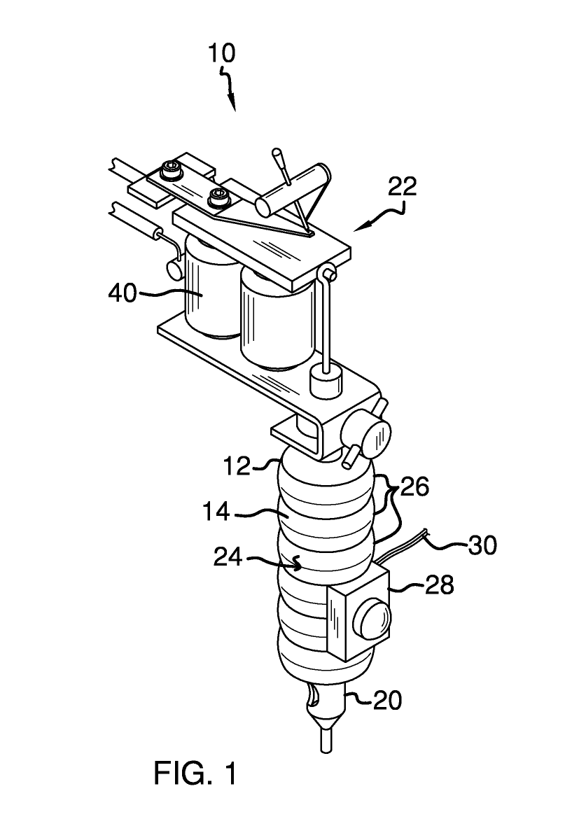

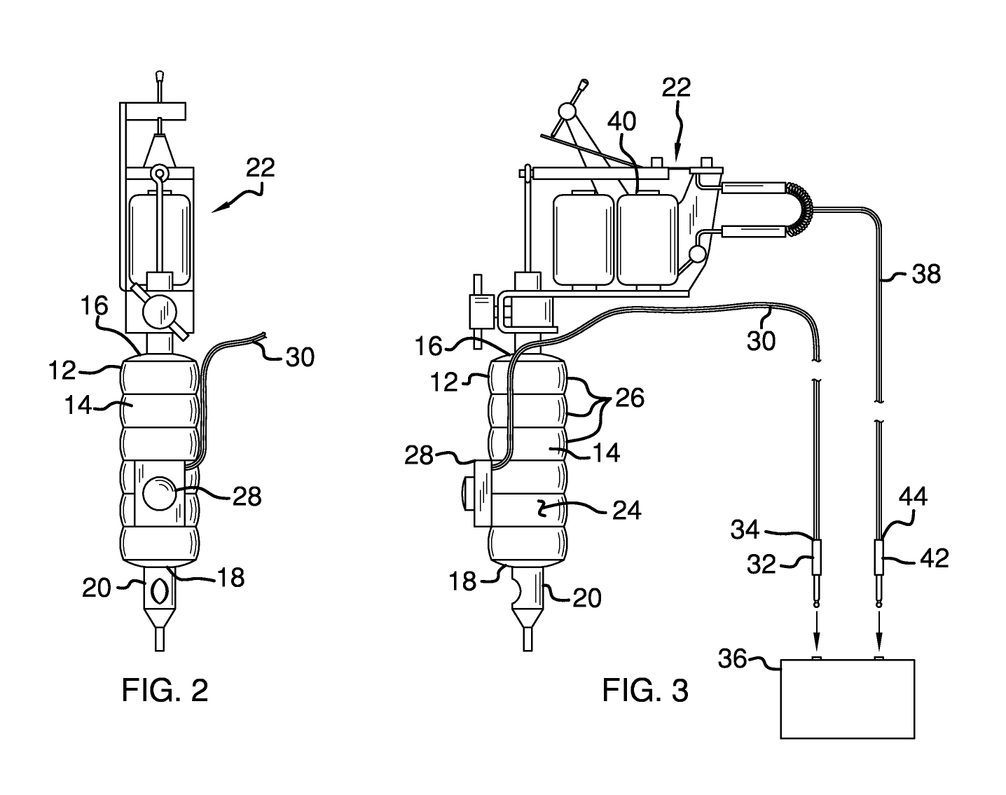

With reference now to the drawings, and in particular to FIGS. 1 through 3 thereof, a new switch device embodying the principles and concepts of an embodiment of the disclosure and generally designated by the reference numeral 10 will be described.

As best illustrated in FIGS. 1 through 3, the tattoo gun switch assembly 10 generally comprises a grip 12. The grip 12 has an outer wall 14 extending between each of a top end 16 and a bottom end 18 of the grip 12. The grip 12 is elongated between the top end 16 and the bottom end 18 such that the grip 12 is structured to have a cylindrical shape. Moreover, the grip 12 is substantially hollow.

Each of the top end 16 and the bottom end 18 is open to insertably receive a needle tube 20 of a tattoo gun 22. The tattoo gun 22 may be an electric tattoo gun or the like. An outer surface 24 of the outer wall 14 comprises a plurality of raised rings 26 extending around an entire circumference of the grip 12. The raised rings 26 are evenly distributed between the top end 16 and the bottom end 18. The grip 12 is grasped by a user while the tattoo gun 22 is being used.

A switch 28 is coupled to the outside surface 24 of the outer wall 14 to be accessible to the user. The switch 28 replaces a foot switch. A first conductor 30 is electrically coupled to the switch 12. A first plug 32 is electrically coupled to a free end 34 of the first conductor 28. The first plug 32 is electrically coupled to a power source 36. The power source 36 may be a transformer or the like.

A second conductor 38 is electrically coupled to a motor 40 in the tattoo gun 22. A second plug 42 is electrically coupled to an uncoupled end 44 of the second conductor 38. The second plug 42 is electrically coupled to the power source 36. Thus, the switch 28 actuates and de-actuates the motor 40 in the tattoo gun 22.

In use, the user engages the switch 28 to actuate and de-actuate the tattoo gun 22. The assembly 10 eliminates the need to utilize the foot switch in the convention of tattooing. Additionally, the assembly 10 increases a level of comfort for the user while the user employs the tattoo gun 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tattoo gun switch assembly comprising:
a grip structured to have a cylindrical shape wherein said grip is configured to be coupled to a tattoo gun; and
a switch coupled to said grip wherein said switch is configured to be accessible to a user thereby replacing a foot switch.

2. The assembly according to claim 1, wherein said grip having an outer wall extending between each of a top end and a bottom end of said grip, said grip being elongated between said top end and said bottom end, said grip being substantially hollow, each of said top end and said bottom end being open such that said grip is configured to insertably receive a needle tube of the tattoo gun, said switch being coupled to an outside surface of said outer wall.

3. The assembly according to claim 2, further comprising an outer surface of said outer wall comprising a plurality of raised rings extending around an entire circumference of said grip, said raised rings being evenly distributed between said top end and said bottom end.

4. The assembly according to claim 1, further comprising a first conductor electrically coupled to said switch, said first conductor being electrically coupled to a power source.

5. The assembly according to claim 4, further comprising a second conductor electrically coupled to the tattoo gun, said second conductor being electrically coupled to the power source wherein said switch actuates and de-actuates the tattoo gun.

6. A tattoo gun switch assembly comprising:
a grip, said grip having an outer wall extending between each of a top end and a bottom end of said grip, said grip being elongated between said top end and said bottom end such that said grip is structured to have a cylindrical shape, said grip being substantially hollow, each of said top end and said bottom end being open such that said grip is configured to insertably receive a needle tube of the tattoo gun, an outer surface of said outer wall comprising a plurality of raised rings extending around an entire circumference of said grip, said raised rings being evenly distributed between said top end and said bottom end;
a switch coupled to said outside surface of said outer wall wherein said switch is configured to be accessible to a user thereby replacing a foot switch;
a first conductor electrically coupled to said switch, said first conductor being electrically coupled to a power source; and
a second conductor electrically coupled to the tattoo gun, said second conductor being electrically coupled to the power source wherein said switch actuates and de-actuates the tattoo gun.
